(19) United States
(12) Patent Application Publication
(10) Pub. No.: US 2002/0103305 A1
(43) Pub. Date: Aug. 1, 2002

(54) Membranes comprising aminoalcohols in hydrophilic polymers (law522)

(76) Inventor: W.S. Winston Ho, Annandale, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 10/071,374

(22) Filed: Feb. 8, 2002

Related U.S. Application Data
(63) Continuation of application No. 09/632,994, filed on Aug. 4, 2000.
Application No. 09/632,994 is a continuation of application No. 09/375,946, filed on Aug. 17, 1999, now abandoned.
Application No. 09/375,946 is a continuation of application No. 09/172,739, filed on Oct. 14, 1998, now abandoned.
Application No. 09/172,739 is a continuation of application No. 08/815,016, filed on Mar. 14, 1997, now abandoned.

(51) Int. Cl. C08F 8/30

(52) U.S. Cl. 525/374

(57) ABSTRACT

The present invention is directed toward a composition comprising a hydrophylic polymer and at least one aminoalcohol, the aminoalcohol being present in an amount ranging from about 10 to 80 wt % based on the total weight of the composition.

Another embodiment of the present invention comprises a membrane suitable for use in separating CO₂ from gas streams containing CO₂, especially H₂ rich gas streams containing CO₂ and CO.

### FIELD OF THE INVENTION

The present invention relates to polymer compositions particularly suitable for forming membranes that are useful in separating CO₂ from gaseous streams, particularly from gas streams containing H₂, CO₂ and CO.

### BACKGROUND OF THE INVENTION

There are numerous industrial processes in which gas streams are produced containing CO₂ as one of the components of the gas stream and in which it is desirable to selectively remove the CO₂ from the other components. One technique used to selectively remove CO₂ from process gas streams is to absorb the CO₂ in an amine solution. Another technique used is to adsorb the CO₂ on a molecular sieve.

The use of membranes to separate components in a process stream has long been pursued by the scientific and industrial community. Nonetheless, there remains a need for a membrane that has a high CO₂ permeability and selectivity.

U.S. Ser. No. 499,267 (by this inventor) covers membranes comprising salts of aminoacids in hydrophilic polymers for removal of CO₂ from gas streams containing CO₂. That patent application does not cover the membrane compositions disclosed in the present invention.

It is an object of the present invention to provide novel polymer compositions that are suitable in formation of membranes useful in separating CO₂ from process gases, particularly from a H₂ rich gas stream containing CO₂ and CO.

### SUMMARY OF THE INVENTION

In its simplest sense, the present invention is directed toward a composition comprising a hydrophilic polymer and at least one aminoalcohol, the aminoalcohol being present in an amount ranging from about 10 to about 80 wt % based on the total weight of the composition.

Another embodiment of the present invention comprises a membrane suitable for use in separating CO₂ from gas streams containing CO₂, especially H₂ rich gas streams containing CO₂ and CO.

These and other embodiments of the present invention will become apparent upon a reading of the detailed description of the invention which follows.

### DETAILED DESCRIPTION OF THE INVENTION

The compositions of the present invention comprise a hydrophilic polymer and at least an aminoalcohol, the aminoalcohol being present in an amount ranging from about 10 to about 80 wt % based on the total weight of the composition and preferably about 40 to about 65 wt %.

The hydrophilic polymers suitable in the practice of the present invention include polyvinylalcohol, polyvinylpyrrolidone, polyethyleneoxide, polyacrylamide, polyvinylacetate, blends and copolymers thereof. In general, these polymers will have weight average molecular weights in the range of about 30,000 to 2,000,000 and preferably in the range from about 50,000 to 200,000. Particularly preferred polymers useful in the present invention are polyvinylalcohols having molecular weights in the range from about 50,000 to 150,000.

The aminoalcohols in the compositions of the present invention are selected from those having the formulae:

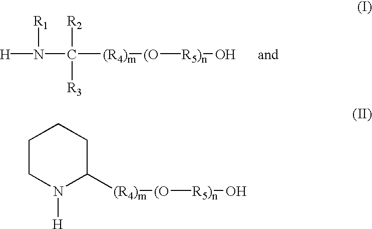

wherein R₁, R₂ and R₃ are hydrogen or alkyl groups having from 1 to 4 carbon atoms, R₄ is an alkylene group having from 1 to 4 carbon atoms or an alkyleneimino group of from 3 to 6 carbons and 1 to 2 nitrogen atoms, R₅ is an alkylene group having from 2 to 4 carbon atoms or an alkyleneimino group of from 4 to 6 carbons and 1 to 2 nitrogen atoms, m is an integer ranging from 1 to 4, and n is an integer ranging from 0 to 4.

As previously stated, the amount of aminoalcohol to be present in the composition is in the range from about 10 to 80 wt % based on the total weight of the composition, and preferably about 40 to about 65 wt %.

The compositions of the present invention are prepared by first forming a solution of the polymer and the aminoalcohol in a suitable solvent such as water. Generally, the amount of water employed will be in the range from about 70% to 95%. The composition can then be recovered from the solution by removing the solvent, for example, by allowing the solvent to evaporate; however, it is preferred to use the solution in forming a nonporous membrane. Thus, the resulting solution is formed into a nonporous membrane by techniques well known in the art. For example, the polymer solution can be cast onto a solid support with techniques such as “knife casting” or “dip casting”. Knife casting, of course, is a process in which a knife is used to draw a polymer solution across a flat surface to form a thin film of the polymer solution of uniform thickness after which the solvent of the polymer solution is evaporated, at ambient or temperatures up to about 100° C., to yield the fabricated membrane. When, for example, a glass plate is used as the flat surface, the membrane can then be removed from the support providing a free standing polymer membrane. When, alternatively, the flat surface used is a non-selective porous support such as porous polytetrafluoroethylene, the resulting membrane is a composite membrane comprising the selective membrane polymer and the support. Dip casting is the process in which the polymer solution is contacted with a non-selective porous support. Then excess solution is permitted to drain from the support, and the solvent of the polymer solution is evaporated at ambient or elevated temperatures as above. The membrane comprises both the polymer and the porous support.

The membranes of the present invention also may be shaped in the form of hollow fibers, tubes, films, sheets and the like.

In an alternate embodiment of the present invention, a cross-linking agent is added to the polymer and aminoalcohol solution before forming a membrane from it.

Suitable cross-linking agents include formaldehyde, divinyl sulfone, toluene diisocyanate, glyoxyal, trimethylol melamine, terephthalatealdehyde, epichlorohydrin, vinyl acrylate, and maleic anhyride. Formaldehyde, divinyl sulfone and toluene dissocyanate are particularly preferred.

The amount of cross-linking agent employed will be in the range of about 1 to about 20 wt % based on the total weight of the solid composition formed from the solution.

Membranes formed from the solution containing a cross-linking agent typically are heated at a temperature and for a time sufficient for cross-linking to occur. Generally, cross-linking temperatures in the range from about 80° C. to about 120° C. are employed. Cross-linking will occur in from about 1 to 72 hours.

As indicated previously, the compositions of the present invention are especially suitable for use as a nonporous membrane for separating CO₂ from CO₂-containing gas streams. Accordingly, CO₂ is removed from a gaseous feed stream by contacting the stream against one side, a first side, of the membrane and by withdrawing at the obverse or second side of the membrane a permeate comprising the CO₂. The permeate comprises the CO₂ in increased concentration relative to the feed stream. By “permeate” is meant that portion of the feed stream which is withdrawn at the second side of the membrane, exclusive of other fluids such as a sweep gas or liquid which may be present at the second side of the membrane.

The present invention will be better understood by reference to the following examples which are offered by way of illustration not limitation.

### EXAMPLES

In the examples which follow, the separation factor (selectivity) for CO₂ vs. H₂ is expressed as follows:

$$Separation Factor = \frac{{CO}_{2} / {H}_{2} concentration ratio in the permeate}{{CO}_{2} / {H}_{2} concentration ratio in the retentate}$$

The retentate refers to the mixture on the feed side of the membrane which is rejected by the membrane under the operating conditions. Permeability is expressed in Barrer (Barrer=10⁻¹⁰ cm³(STP).cm/(cm².s.cm Hg)). The permeability is determined by the use of the relationship between permeability and flux as follows:

flux=permeability (p₁−p₂)/L

where p₁ and p₂ are the CO₂ partial pressures in the retentate and permeate streams, respectively, and L is the membrane thickness. The partial pressures are determined based on concentration measurements by gas chromatography and total pressure measurements by pressure gauges. The flux is determined based on concentration measurements obtained by gas chromatography and permeate stream flow rate measurements by a flow meter.

### Example 1

### Synthesis of 60 wt % Monoethanolamine and 40 wt % Polyvinylalcohol Membrane

To 21.83 g of water was added 4.01 g of polyvinylalcohol (PVA) with stirring and heating at about 75° C. until a clear solution of the polymer was obtained. To this solution was added 6.028 g of monoethanolamine with stirring for about 10 minutes to obtain a clear, homogeneous solution. The solution was then centrifuged while cooling for about 5 minutes. Following centrifugation, a membrane was knife-cast with a gap setting of 6 mils onto a support of microporous polytetrafluoroethylene. Water was allowed to evaporate from the membrane overnight in a nitrogen box at ambient conditions. The membrane was then heated in an oven at 90° C. for about 7 hours. The resulting membrane comprised 60 wt % monoethanolamine and 40 wt % polyvinylaclohol on the microporous polytetrafluoroethylene support, and had a thickness of 15.2 microns (exclusive of the support).

### Example 2

### Synthesis of 60 wt % 2-Amino-2-Methyl-1-Propanol and 40 wt % Polyvinylalcohol Membrane

The membrane was synthesized according to the procedure described in Example 1 except 6.097 g of 2-amino-2-methyl-1-propanol (AMP) was used. The resulting membrane comprised about 60 wt % AMP and 40 wt % polyvinylalcohol on the microporous poplytetrafluoroethylene support, and had a thickness of 49.7 microns (exclusive of the support).

### Example 3

### Synthesis of 71.4 wt % 2-Amino-2-Methyl-1-Propanol, 21.4 wt %

Polyvinylalcohol and 7.2 wt % Formaldehyde Membrane To 5 g of water was added 6.66 g of 2-amino-2-methyl-1-propanol (AMP) with stirring while heating to about 70° C. for about 10 minutes. To the AMP solution were added 1.995 g of polyvinylalcohol (PVA) and 3 g of water with stirring at this temperature until a clear solution was obtained. Then, 1.833 g of a solution containing 37 wt % formaldehyde in water (0.678 g of formaldehyde) was added to the AMP/PVA solution at 70° C. with stirring for 10 minutes. Additional 11 g of water was added to the AMP/PVA/formaldehyde solution at the same temperature with stirring for about 30 minutes to obtain a clear, homogeneous solution. Following centrifugation, a membrane was knife-cast with a gap setting of 8 mils onto a support of microporous polytetrafluoroethylene. Water was allowed to evaporate from the membrane overnight in a nitrogen box under ambient conditions. The membrane was then heated in an oven at about 80° C. for over a weekend (about 65 hours). The resulting membrane comprised 71.4 wt % AMP, 21.4 wt % PVA and 7.2 wt % formaldehyde residue on the microporous polytetrafluoroethylene support, and had a thickness of 27.0 microns (exclusive of the support).

### Example 4

### Permeation Measurement of Membrane of Example 1

In the permeation measurement to evaluate the separation factor (selectivity) of CO₂ vs. H₂ and the permeability of CO₂, the membrane was placed in a permeation cell comprising the first compartment for contacting a feed stream against the upstream side of the membrane and the second compartment for withdrawing the permeate from the downstream side of the membrane. The active membrane area in the cell was 63.62 cm². A feed gas comprising 75% H₂ and 25% CO₂ under a total pressure of about 3 atm at about ambient temperature (23° C.) was contacted against the membrane at a flow rate of about 120 cm³/min. The permeate was swept by nitrogen under a pressure of about 1 atm and a total flow rate of 10-50 cm³/min for the permeate/nitrogen stream. Both the feed and the sweep streams were humidified by bubbling through deionized water prior to contacting the membrane.

For the membrane of Example 1 comprising 60 wt % monoethanolamine and 40 wt % polyvinylalcohol, the CO₂/H₂ selectivity result obtained was 15, and the CO₂ permeability was 105 Barrers.

### Example 5

### Permeation Measurement of Membrane of Example 2

The membrane of Example 2 comprising 60 wt % 2-amino-2-methyl-1-propanol and 40 wt % polyvinylalcohol was evaluated in the same way described in Example 4. The CO₂/H₂ selectivity result obtained was 15, and the CO₂ permeability was 81 Barrers.

As shown in Examples 4 and 5, the membranes of this invention may be employed for removal Of CO₂ from a gas mixture of 75% H₂ and 25% CO₂. This gas mixture simulates a typical reformate based on the relative ratio of H₂ and CO₂.

What is claimed is:

1. A composition comprising:
a hydrophilic polymer and at least one aminoalcohol, the aminoalcohol being present in an amount ranging from about 10 to about 80 wt % based on the total weight of the composition, wherein the aminoalcohol is selected from aminoalcohols having the formulae: 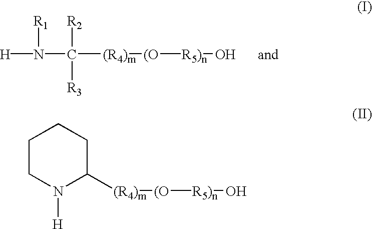
wherein R₁, R₂ and R₃ are hydrogen or alkyl groups having from 1 to 4 carbon atoms, R₄ is an alkylene group having from 1 to 4 carbon atoms or an alkyleneimino group of from 3 to 6 carbons and 1 to 2 nitrogen atoms, R₅ is an alkylene group having from 2 to 4 carbon atoms or an alkyleneimino group of from 4 to 6 carbons and 1 to 2 nitrogen atoms, m is an integer ranging from 1 to 4, and n is an integer ranging from 0 to 4.

2. The composition of claim 1 wherein the hydrophylic polymer is selected from the group consisting of polyvinylalcohol, polyvinylpyrrolidone, polyethyleneoxide, polyacrylamide, polyvinylacetate, blends and copoloymers thereof.

3. The composition of claim 2 wherein the polymer is polyvinylalochol.

4. The composition of claim 2 including from about 1 to about 20 wt % of a cross-linking agent based on the total weight of composition.

5. The composition of claim 4 wherein the cross-linking agent is selected the group consisting of formaldehyde, divinyl sulfone, toluene disocyanate, glyoxal, trimethylol melamine, terepththalaldehyde, epichlorohydrin, vinyl acrylate, and maleic anhydride.

6. The composition of claim 4 wherein the cross-linking agent is formaldehyde.

7. A nonporous membrane formed from the composition of claim 1, 2 or 5.

8. A process for separating CO₂ from a CO₂-containing gas stream comprising:
contacting a CO₂-containing gas stream with one side of a non-porous, CO₂ selectively permeable membrane comprising a hydrophilic polymer and at least one aminoalcohol, the aminoalcohol being present in an amount ranging from about 10 to about 80 wt % based on the weight of the composition whereby CO₂ is selectively transported through the membrane; and
withdrawing from the obverse side of the membrane a permeate containing CO₂ where CO₂ is selectively removed from the gaseous stream.

9. A method for producing a nonporous membrane having proper-ties sufficient to enable separation of CO₂ from a gaseous stream containing CO₂, the method comprising:
forming a casting solution of a solvent, a hydrophylic polymer and at least one aminoalcohol, the aminoalcohol being present in an amount ranging from about 10 to about 80 wt % based on the total weight of polymer and salt;
casting the solution on a substrate; and
evaporating the solvent whereby a nonporous membrane is formed.

10. The process of claim 8 and the method of claim 9 wherein the aminoalcohol is selected from aminoalcohols having the formulae: 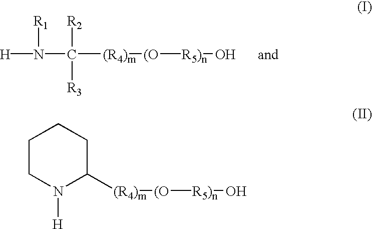
wherein R₁, R₂ and R₃ are hydrogen or alkyl groups having from 1 to 4 carbon atoms, R₄ is an alkylene group having from 1 to 4 carbon atoms or an alkyleneimino group of from 3 to 6 carbons and 1 to 2 nitrogen atoms, R₅ is an alkylene group having from 2 to 4 carbon atoms or an alkyleneimino group of from 4 to 6 carbons and 1 to 2 nitrogen atoms, m is an integer ranging from 1 to 4, and n is an integer ranging from 0 to 4.

11. The method of claim 9 including adding a cross-linking agent to the polymer solution.
